(19) United States
(12) Patent Application Publication
(10) Pub. No.: US 2026/0005428 A1
(43) Pub. Date: Jan. 1, 2026

(54) FOLDABLE ELECTRONIC DEVICE

(71) Applicant: HUAWEI TECHNOLOGIES CO., LTD., Shenzhen (CN)

(72) Inventors: Lijun Ying, Shanghai (CN); Dong Yu, Shanghai (CN); Deyong Ge, Shanghai (CN); Zhangfei Yin, Shanghai (CN); Fangchao Zhao, Shanghai (CN)

(73) Assignee: HUAWEI TECHNOLOGIES CO., LTD., Shenzhen (CN)

(21) Appl. No.: 19/320,473

(22) Filed: Sep. 5, 2025

Related U.S. Application Data
(63) Continuation of application No. PCT/CN2024/086649, filed on Apr. 8, 2024.

(30) Foreign Application Priority Data
Apr. 28, 2023 (CN) 202310487175.9

(51) Int. Cl. H01Q 1/24

(52) U.S. Cl. CPC H01Q 1/243

(57) ABSTRACT

A foldable electronic device includes an antenna, a hinge component, a first housing, and a second housing. The first housing includes a second side frame and a third side frame that are respectively located at two ends of the hinge component, and a first side frame that is connected to ends of the second side frame and the third side frame. When the antenna is located on the first side frame, a distance between a feed point and an edge that is of the ground plane and that faces the second or the third side frame is ⅛ to ⅜ of an operating wavelength of the antenna; or when the antenna is located on the second or the third side frame, a distance between the feed point and the hinge component is ⅛ to ⅜ of the operating wavelength of the antenna.

### CROSS-REFERENCE TO RELATED APPLICATIONS

This application is a continuation of International Application No. PCT/CN2024/086649, filed on Apr. 8, 2024, which claims priority to Chinese Patent Application No. 202310487175.9, field on Apr. 28, 2023. The disclosures of the aforementioned applications are hereby incorporated by reference in their entireties.

### TECHNICAL FIELD

This application relates to the field of communication technologies, and in particular, to a foldable electronic device.

### BACKGROUND

An antenna is an important component for implementing a communication function of a terminal device. A mobile phone and a tablet computer are used as an example. Antennas are disposed to implement communication functions of the mobile phone and the tablet computer. However, in a related technology, when a user is located in an area in which it is difficult for base station signals to reach, for example, outdoors, even if a terminal device has an antenna function, functions such as SMS message, call, and multimedia of the terminal device are unavailable.

### SUMMARY

This application provides a foldable electronic device. The foldable electronic device can implement communication with a satellite.

A foldable electronic device provided in this application includes a first housing, a second housing, a hinge component, and an antenna. For example, the first housing and the second housing are respectively disposed on two sides of the hinge component, and at least one of the first housing and the second housing is rotatably connected to the hinge component, so that the first housing can open and close relative to the second housing, and the foldable electronic device can be switched between the unfolded state, a half-folded state, and the folded state. For example, when an included angle between the first housing and the second housing is a preset angle, a relative location between the first housing and the second housing can be maintained, to facilitate a corresponding operation of a user when the foldable electronic device is at the preset angle. During an arrangement of the first housing, the first housing includes a plurality of side frames, the plurality of side frames include at least a first side frame, a second side frame, and a third side frame, where the second side frame and the third side frame are respectively located at two ends of the hinge component, and the first side frame is connected between the second side frame and the third side frame, and is located between sides that are of the second side frame and the third side frame and that are away from the hinge component. Further, a metal part in the first housing, a metal part in the second housing, and a metal part in the hinge component are electrically connected as a ground plane. The antenna is located on a side frame of the first housing. For example, the antenna includes a primary radiator and a feed point located on the primary radiator. When the antenna is located on the first side frame, the distance between the feed point and the edge that is of the ground plane and that faces the second side frame or the third side frame is ⅛ to ⅜ of the operating wavelength of the antenna. When the antenna is located on the second side frame or the third side frame, the distance between the feed point and the axis of the hinge component is ⅛ to ⅜ of the operating wavelength of the antenna.

In this solution, a ground current excited by the antenna on the ground plane can generate two current components that are perpendicular to each other, have equal amplitudes, and have a phase difference of 90°. The two current components can form a circularly polarized radiation wave to further implement communication with a satellite. When the antenna is located on the first side frame, the distance between the feed point of the antenna and the edge that is of the ground plane and that faces the second side frame or the third side frame is ⅛ to ⅜ of the operating wavelength of the antenna, and the preset angle exists between the first housing and the second housing, a main radiation direction of the circularly polarized radiation wave formed by the antenna is located between the first housing and the second housing, and extends from the first housing toward a direction away from the first housing and the second housing. When the included angle between the first housing and the second housing is the preset angle, the relative location between the first housing and the second housing can be maintained. In this way, the second housing can reflect the circularly polarized radiation wave once, to improve a gain of the antenna. In addition, in the second housing, the ground current on the ground plane can provide a co-polarized component for the circularly polarized radiation wave, to further improve the gain of the antenna. Finally, the foldable electronic device can form the circularly polarized radiation wave used for satellite communication, and can improve a satellite communication capability from at least two aspects, improve a data amount and quality of satellite communication, and better meet a satellite communication requirement. For example, when the antenna is located on the second side frame or the third side frame, and the distance between the feed point of the antenna and the axis of the hinge component is ⅛ to ⅜ of the operating wavelength of the antenna, the second housing includes a fourth side frame, a fifth side frame, and a sixth side frame, the fourth side frame is opposite to the hinge component, the fifth side frame and the second side frame are located on a same plane, and the sixth side frame and the third side frame are located on a same plane. In this solution, the main radiation direction of the circularly polarized radiation wave formed by the antenna is located between the first housing and the second housing, and points from one of the plane on which the second side frame and the fifth side frame are located and the plane on which the third side frame and the sixth side frame are located, toward the other, and the foldable electronic device can also implement communication with the satellite. In this way, when the user is located in an area in which it is difficult for base station signals to reach, for example, outdoors, functions such as SMS message, call, and multimedia of the foldable electronic device are still available.

In an embodiment, when the antenna is located on the first side frame, the distance between the feed point and the edge that is of the ground plane and that faces the second side frame or the third side frame is ¼ of the operating wavelength of the antenna. In this solution, the corresponding edge that is of the ground plane and that faces the second side frame or the third side frame is a forced boundary of a ground current, so that two current components generated by the ground current can form a circularly polarized radiation wave, and the foldable electronic device can implement communication with the satellite.

In another embodiment, when the antenna is located on the second side frame or the third side frame, the distance between the feed point and the axis of the hinge component is ¼ of the operating wavelength of the antenna. In this solution, the axis of the hinge component is a forced boundary of the ground current, so that two current components generated by the ground current can form a circularly polarized radiation wave, and the foldable electronic device can implement communication with the satellite.

During an arrangement of the first housing, in an embodiment, the first side frame is parallel to the hinge component, and both the second side frame and the third side frame are perpendicular to the first side frame and the hinge component. A cross section of first accommodating space jointly enclosed by a side frame of the first housing and the hinge component is rectangular, and a planar contour of a ground plane formed by the metal part in the first housing is approximately the same as a planar contour of the first accommodating space. Therefore, the ground plane formed by the metal part in the first housing is also approximately rectangular. The ground plane formed by the metal part in the first housing is approximately rectangular. This helps generate the current components with a phase difference of 90° on the ground plane, so that the antenna forms a more desirable circularly polarized radiation wave.

In an embodiment, when the foldable electronic device is in a use state, the antenna is located at the top of the foldable electronic device. For example, the foldable electronic device is a mobile phone. When using the mobile phone, the user usually holds the bottom of the mobile phone. In this case, a hand of the user absorbs an electromagnetic wave radiated by an antenna, affecting performance of the antenna. This problem can be avoided by placing the antenna on the top of the foldable electronic device.

In an embodiment, the preset angle is 60° to 120°. In other words, the included angle between the first housing and the second housing can be maintained within 60° to 120°. For example, the preset angle is 90°, so that satellite communication performance of the antenna is better.

It is not difficult to understand that the foldable electronic device further includes a flexible display, where the flexible display continuously covers the first housing, the hinge component, and the second housing, and the flexible display is fastened to both the first housing and the second housing.

Further, in an embodiment, the foldable electronic device further includes a folded state detection component and a processing unit. The folded state detection component is configured to detect an angle of the included angle between the first housing and the second housing. The processing unit stores a correspondence between earth coordinates and an elevation angle of the satellite, and further stores a correspondence between the included angle between the first housing and the second housing and a main radiation direction of the antenna. Both the folded state detection component and the flexible display are electrically connected to the processing unit, so that the processing unit can control, based on feedback from the folded state detection component, the flexible display to guide a user to align the main radiation direction of the antenna with the satellite. This enhances the satellite communication capability of the foldable electronic device.

In an embodiment, the antenna is a left-handed antenna or an inverted F antenna.

In an embodiment, the side frame is a metal side frame, and the primary radiator of the antenna is a part of the metal side frame.

In another embodiment, the side frame is an insulating side frame, and the primary radiator of the antenna is a metal coating or a metal part of a flexible circuit board.

### BRIEF DESCRIPTION OF DRAWINGS

FIG. 1 is a diagram of a structure of a foldable electronic device in a folded state according to an embodiment of this application;

FIG. 2 is a diagram of a structure of a foldable electronic device in an unfolded state according to an embodiment of this application;

FIG. 3 is a diagram of a structure of a foldable electronic device in a half-folded state according to an embodiment of this application;

FIG. 4 is a diagram of a structure of a foldable electronic device in a half-folded state according to an embodiment of this application;

FIG. 5 is a diagram of a location of an antenna in a foldable electronic device in an embodiment according to embodiments of this application;

FIG. 6 is a left-handed circular polarization pattern of an antenna of the foldable electronic device shown in FIG. 5;

FIG. 7 is a total radiation pattern of an antenna of the foldable electronic device shown in FIG. 5;

FIG. 8 is a gain pattern of an antenna of the foldable electronic device shown in FIG. 5;

FIG. 9 is a gain pattern of an antenna of the foldable electronic device shown in FIG. 5 that is in a flat state;

FIG. 10 is a diagram of a location of an antenna in a foldable electronic device in an embodiment according to embodiments of this application;

FIG. 11 is a diagram of a location of an antenna in a foldable electronic device in an embodiment according to embodiments of this application;

FIG. 12 is a diagram of a location of an antenna in a foldable electronic device in an embodiment according to embodiments of this application;

FIG. 13 is a left-handed circular polarization pattern of an antenna of the foldable electronic device shown in FIG. 12;

FIG. 14 is a total radiation pattern of an antenna of the foldable electronic device shown in FIG. 12;

FIG. 15 is a simulation diagram of an axial ratio of a circularly polarized radiation wave radiated by an antenna of the foldable electronic device shown in FIG. 12;

FIG. 16 is a simulation diagram of an axial ratio of a circularly polarized radiation wave radiated by an antenna of the foldable electronic device shown in FIG. 12 in a flat state;

FIG. 17 is a diagram of a location of an antenna in a foldable electronic device in some embodiments according to embodiments of this application;

FIG. 18 is a diagram of a location of an antenna in a foldable electronic device in some embodiments according to embodiments of this application;

FIG. 19 is a diagram of a location of an antenna in a foldable electronic device in some embodiments according to embodiments of this application;

FIG. 20 is a diagram of a location of an antenna in a foldable electronic device in some embodiments according to embodiments of this application; and

FIG. 21 is a diagram of a foldable electronic device in an embodiment according to embodiments of this application.

Reference numerals: 1: first housing; 11: first side frame; 12: second side frame; 13: third side frame; 2: second housing; 3: hinge component; 4: antenna; 5: folded state detection component; 6: processing unit; 7: flexible display.

### DESCRIPTION OF EMBODIMENTS

An antenna is an important component for implementing a communication function of a terminal device. A mobile phone and a tablet computer are used as an example. Antennas are disposed to implement communication functions of the mobile phone and the tablet computer. However, in a related technology, when a user is located in an area in which it is difficult for base station signals to reach, for example, outdoors, a terminal device loses an antenna function. Consequently, functions such as SMS message, call, and multimedia of the terminal device are all unavailable, causing significant inconvenience to the user.

Based on this, an embodiment of this application provides a foldable electronic device that can implement a satellite communication function, to resolve the foregoing problem. It should be noted that the foldable electronic device provided in this application includes but is not limited to a terminal device having a flexible display, for example, a mobile phone, a tablet computer, a notebook computer, a monitor, or a vehicle-mounted apparatus. To make the objectives, technical solutions, and advantages of this application clearer, the following further describes this application in detail with reference to the accompanying drawings.

Terms used in the following embodiments are merely intended to describe specific embodiments, but are not intended to limit this application. The terms “one”, “a” and “this” of singular forms used in this specification and the appended claims of this application are also intended to include expressions such as “one or more”, unless otherwise specified in the context clearly.

Reference to “an embodiment”, “some embodiments”, or the like described in this specification indicates that one or more embodiments of this application include a specific feature, structure, or characteristic described with reference to the embodiment. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise emphasized in another manner. The terms “include”, “have”, and their variants all mean “include but are not limited to”, unless otherwise emphasized in another manner.

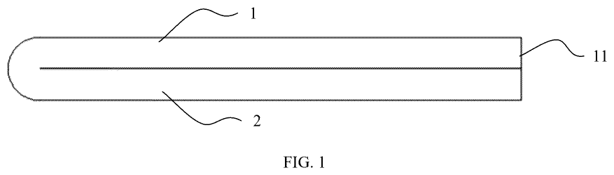

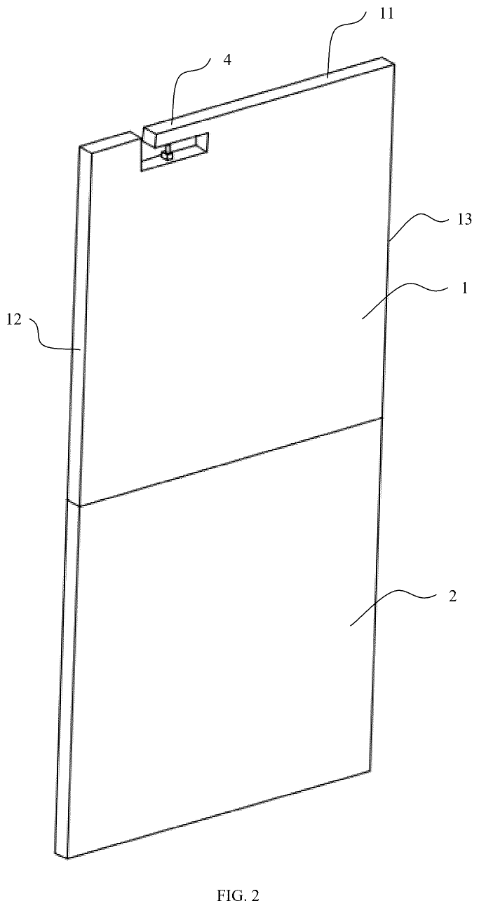

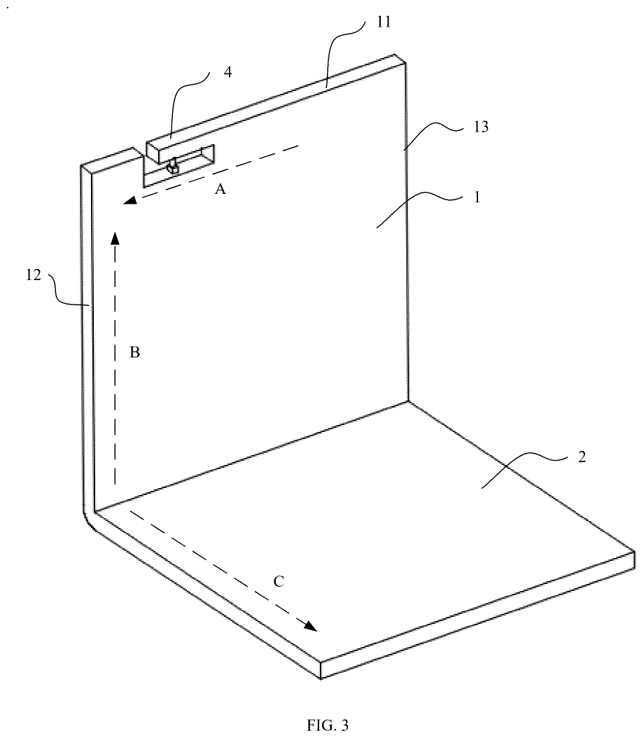

FIG. 1 is a diagram of a structure of a foldable electronic device in a folded state according to an embodiment of this application. FIG. 2 is a diagram of a structure of a foldable electronic device in an unfolded state according to an embodiment of this application. FIG. 3 is a diagram of a structure of a foldable electronic device in a half-folded state according to an embodiment of this application. It is not difficult to understand that the half-folded state is a state between the unfolded state and the folded state. As shown in FIG. 1 to FIG. 3, the foldable electronic device provided in this embodiment of this application includes a first housing 1, a second housing 2, and a hinge component 3 (not shown in the figure). For example, the first housing 1 and the second housing 2 are rotatably connected by using the hinge component 3. That is, the first housing 1 and the second housing 2 are respectively disposed on two opposite sides of the hinge component 3, and at least one of the first housing 1 and the second housing 2 can rotate relative to the hinge component 3, so that the first housing 1 can be opened and closed relative to the second housing 2, and the foldable electronic device can be switched between the unfolded state, the half-folded state, and the folded state. For example, in an embodiment, the first housing 1 is rotatably connected to the hinge component 3. In another embodiment, the second housing 2 is rotatably connected to the hinge component 3. In still another embodiment, both the first housing 1 and the second housing 2 are rotatably connected to the hinge component 3. Further, when an included angle between the first housing 1 and the second housing 2 is a preset angle, a relative location between the first housing 1 and the second housing 2 can be maintained, to facilitate a corresponding operation of a user when the first housing 1 and the second housing 2 are at the preset angle. For example, when the first housing 1 and the second housing 2 are at the preset angle, the user uses a satellite communication function of the foldable electronic device. For example, in an embodiment, the hinge component 3 may include a damping mechanism, or the hinge component 3 may include a locking mechanism, so that when the included angle between the first housing 1 and the second housing 2 is the preset angle, the relative location between the first housing 1 and the second housing 2 can be maintained.

Next, still refer to FIG. 2 and FIG. 3. During an arrangement of the first housing 1, the first housing 1 may include a plurality of side frames. For example, in an embodiment, the first housing 1 includes a first side frame 11, a second side frame 12, and a third side frame 13, where one of the second side frame 12 and the third side frame 13 is disposed at one end of the hinge component 3, the other is disposed at the other end of the hinge component 3, and the first side frame 11 is connected to ends that are of the second side frame 12 and the third side frame 13 and that are away from the hinge component 3. The first side frame 11, the second side frame 12, the third side frame 13, and the hinge component 3 jointly enclose first accommodating space, and a cross section of the first accommodating space may be quadrilateral. It is not difficult to understand that the cross section of the first accommodating space means a cross section of the first accommodating space in a thickness direction perpendicular to the first housing 1.

The foldable electronic device includes a large quantity of metal parts, and the metal parts are distributed at different locations. In an embodiment, a metal part in the first housing 1, a metal part in the second housing 2, and a metal part in the hinge component 3 are electrically connected as a ground plane, and the ground plane is used as the reference ground for an antenna of the foldable electronic device. For example, during an arrangement of the hinge component 3, the hinge component 3 may be of a metal structure. That is, the entire hinge component 3 is used as a component of the ground plane. It may be understood that the first housing 1 and the second housing 2 each include a plurality of side frames, and side frames of the first housing 1 and side frames of the second housing 2 jointly enclose second accommodating space. In this embodiment, it may be considered that a planar contour of the ground plane is approximately the same as a planar contour of the second accommodating space. Certainly, it is not strictly limited herein that the planar contour of the ground plane is the same as the planar contour of the second accommodating space. The planar contour of the ground plane may have a recess, and the planar contour of the second accommodating space may also have a recess and a protruding part, provided that an approximate planar contour of the ground plane is the same as an approximate planar contour of the second accommodating space.

During an arrangement of an antenna 4, the antenna 4 includes a primary radiator and a feed point located on the primary radiator. The primary radiator of the antenna 4 is located on a side frame of the first housing 1. Further, in an embodiment, the antenna 4 is located on the first side frame 11 of the first housing 1, and a distance between a feed point of the antenna 4 and an edge that is of the ground plane and that faces the second side frame 12 or the third side frame 13 is ⅛ to ⅜ of an operating wavelength of the antenna 4. Clearly, an operating wavelength of an antenna is related to an operating frequency band of a target communication satellite, and details are not described herein.

A radiation wave of the satellite is a circularly polarized radiation wave, and the antenna 4 that radiates a circularly polarized radiation wave can communicate with the satellite. As shown in FIG. 3, in the foldable electronic device provided in this embodiment, a ground current excited by the antenna 4 on the ground plane can generate two current components (namely, a current A and a current B). The two current components are perpendicular to each other, have equal amplitudes, and have a phase difference of 90°. Therefore, a circularly polarized radiation wave can be formed, to implement communication with the satellite, and the antenna 4 becomes a satellite antenna. For example, when the antenna 4 is located on the first side frame 11, the distance between the feed point of the antenna 4 and the edge that is of the ground plane and that faces the second side frame 12 or the third side frame 13 is ⅛ to ⅜ of the operating wavelength of the antenna 4, and the preset angle exists between the first housing 1 and the second housing 2, a main radiation direction of the circularly polarized radiation wave formed by the antenna 4 is located between the first housing 1 and the second housing 2, and extends from the first housing 1 toward a direction away from the first housing 1 and the second housing 2, as shown by an arrow F in a diagram of the foldable electronic device in a half-folded state in FIG. 4. It should be understood that the main radiation direction mentioned in this embodiment of this application is a radiation direction that meets a communication condition within an angle range in an antenna pattern. In this solution, the second housing 2 can reflect the circularly polarized radiation wave once, to improve a gain of the antenna 4. In addition, in the second housing 2, a ground current C on the ground plane can provide a co-polarized component for the circularly polarized radiation wave, to further improve the gain of the antenna 4. Finally, the foldable electronic device can form the circularly polarized radiation wave used for satellite communication, and can improve a satellite communication capability from at least two aspects. In this way, when the user is located in an area in which it is difficult for base station signals to reach, for example, outdoors, the foldable electronic device can implement communication with the satellite by using the antenna, to further implement functions such as SMS message, call, and multimedia.

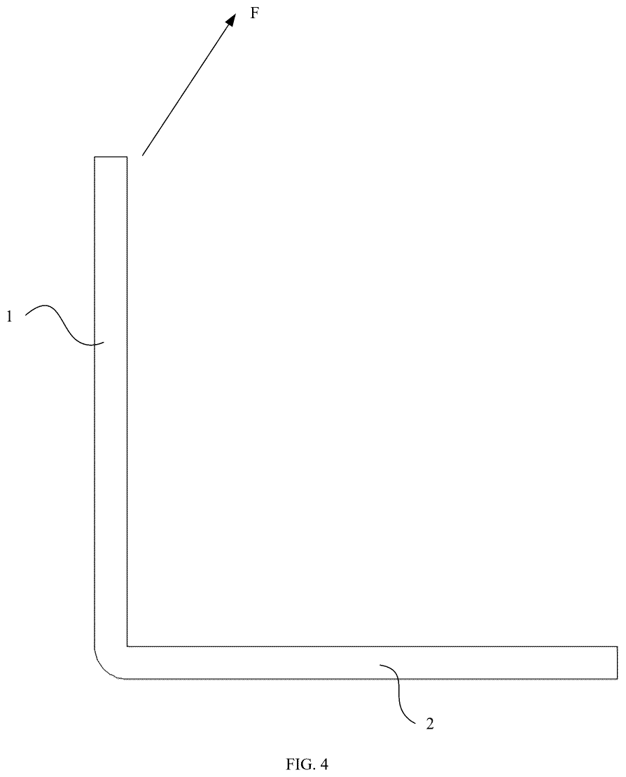

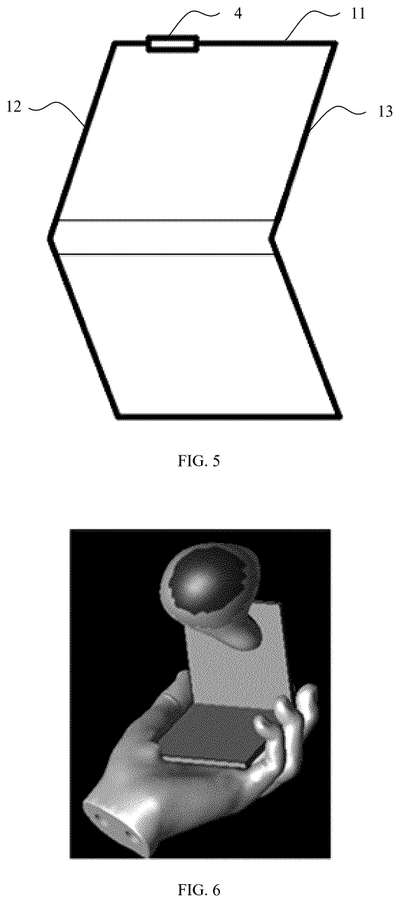

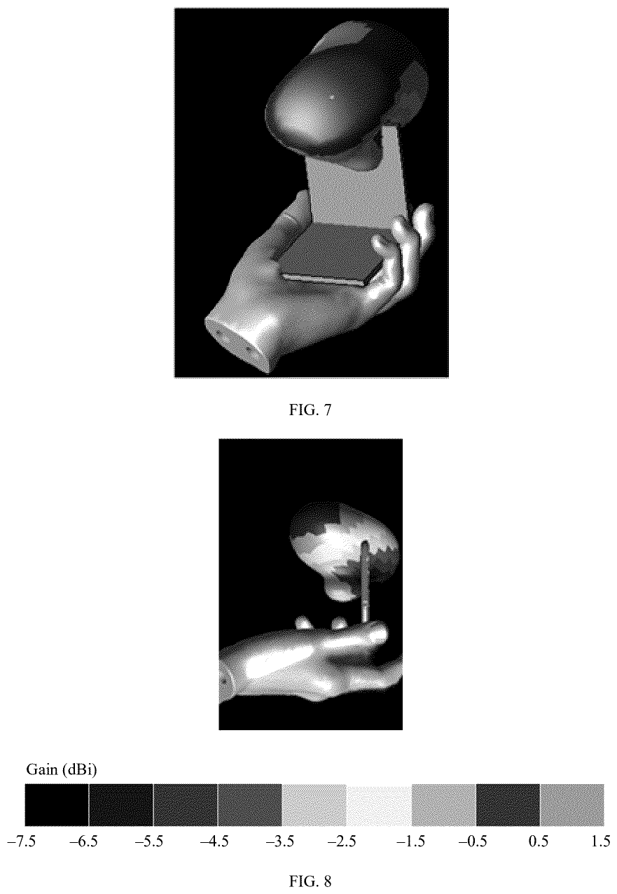

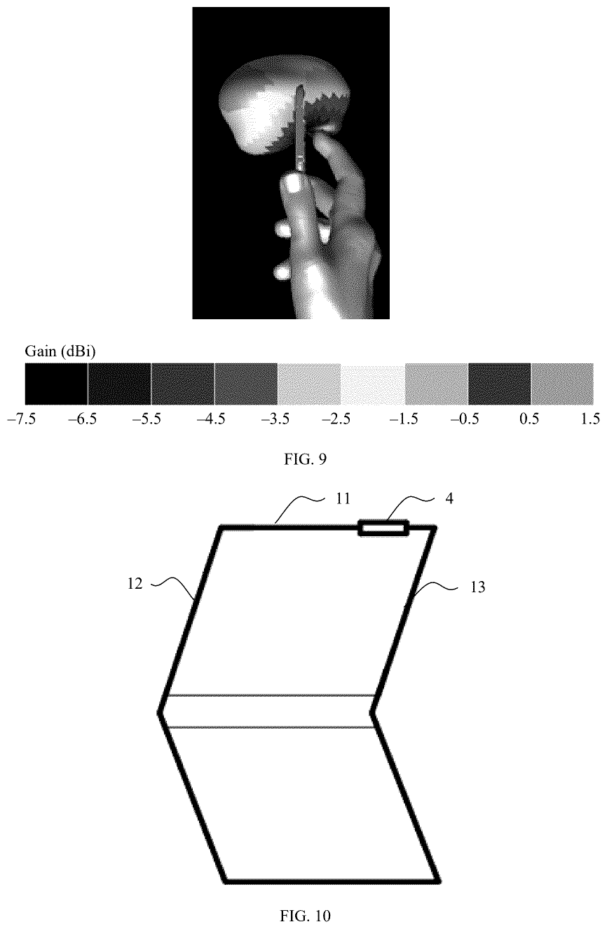

In an embodiment, the antenna 4 is located on the first side frame 11, and a distance between the feed point of the antenna 4 and an edge that is of the ground plane and that faces the second side frame 12 is ¼ of the operating wavelength of the antenna 4. In this case, the edge that is of the ground plane and that faces the second side frame 12 is a forced boundary of a ground current, so that two current components generated by the ground current can form a circularly polarized radiation wave, to implement communication with the satellite. FIG. 5 is a diagram of a location of an antenna in a foldable electronic device in an embodiment. In the figure, the foldable electronic device is in a half-folded state. It can be learned from the foregoing description that a satellite communication capability of the foldable electronic device in this state is stronger. FIG. 6 is a left-handed circular polarization pattern of an antenna of the foldable electronic device shown in FIG. 5. FIG. 7 is a total radiation pattern of an antenna of the foldable electronic device shown in FIG. 5. It can be learned through software reading that a maximum gain of left-handed circular polarization of the antenna in FIG. 6 is 0.3 dBic, and a maximum gain of the antenna in FIG. 7 is 1.75 dBi. Next, refer to FIG. 8 and FIG. 9. FIG. 8 is a gain pattern of an antenna of the foldable electronic device shown in FIG. 5. FIG. 9 is a gain pattern of an antenna of the foldable electronic device shown in FIG. 5 that is in a flat state. It can be learned from FIG. 8 that, when the foldable electronic device is in a half-folded state, a gain in a main radiation direction of the antenna 4 in the foldable electronic device is −0.5 dBi to 0.5 dBi. It can be learned from FIG. 9 that, when the foldable electronic device is in a flat state, a gain in the main radiation direction of the antenna 4 is −1.5 dBi to −0.5 dBi. It can be learned that, in comparison with a conventional flat state of the foldable electronic device, in a half-folded state of the foldable electronic device, a gain of the antenna 4 is about 1 dB to 2 dB, that is, when the foldable electronic device is in a half-folded state, the foldable electronic device has better satellite communication performance. It is not difficult to understand that the flat state of the foldable electronic device is a type of the unfolded state of the foldable electronic device. In another embodiment, the unfolded state of the foldable electronic device may alternatively be that the first housing 1 is at an angle relative to the second housing 2.

Certainly, there may be another location relationship between the antenna 4 and the side frame of the first housing 1. For example, refer to a diagram of a location of an antenna in a foldable electronic device in an embodiment shown in FIG. 10. In this embodiment, the antenna 4 is located on the first side frame 11, a distance between the feed point of the antenna 4 and an edge that is of the ground plane and that faces the third side frame 13 is ¼ of the operating wavelength of the antenna 4, and the edge that is of the ground plane and that faces the third side frame 13 is a forced boundary of the ground current, so that two current components generated by the ground current can form a circularly polarized radiation wave, and have satellite communication performance. In addition, when the foldable electronic device is in the half-folded state shown in FIG. 10, the satellite communication capability of the foldable electronic device is stronger.

It should be noted that, in the foregoing two embodiments, polarization handedness of the circularly polarized radiation waves formed by the antenna 4 is different. One is a left-handed circularly polarized radiation wave, and the other is a right-handed circularly polarized radiation wave. Details are described in the following. The location of the antenna 4 may be set based on polarization handedness of a circularly polarized radiation wave of the target communication satellite. If the target communication satellite of the antenna 4 is a satellite that radiates a left-handed circularly polarized radiation wave, the antenna 4 is disposed at a location at which the antenna 4 can form a left-handed circularly polarized radiation wave. If the target satellite of the antenna 4 is a satellite that radiates a right-handed circularly polarized radiation wave, the antenna 4 is disposed at a location at which the antenna 4 can form a right-handed circularly polarized radiation wave.

In another embodiment, the antenna 4 is located on the second side frame 12 or the third side frame 13, and a distance between the feed point of the antenna 4 and an axis of the hinge component 3 is ⅛ to ⅜ of the operating wavelength of the antenna 4. In this solution, a ground current excited by the antenna 4 on the ground plane can generate two current components that are perpendicular to each other, have equal amplitudes, and have a phase difference of 90°. A circularly polarized radiation wave can be formed to implement communication with the satellite, and the antenna 4 becomes a satellite antenna 4. Further, when the user is located in an area in which it is difficult for base station signals to reach, for example, outdoors, the functions such as SMS message, call, and multimedia can be implemented by using the satellite communication function of the foldable electronic device. For example, the second housing 2 includes a fourth side frame, a fifth side frame, and a sixth side frame, the fourth side frame is opposite to the hinge component 3, the fifth side frame and the second side frame 12 are located on a same plane, and the sixth side frame and the third side frame are located on a same plane. In this solution, the main radiation direction of the circularly polarized radiation wave formed by the antenna is located between the first housing 1 and the second housing 2, and points from one of the plane on which the second side frame and the fifth side frame are located and the plane on which the third side frame and the sixth side frame are located, toward the other. Details are described in the following. Certainly, the main radiation direction of the circularly polarized radiation wave formed by the antenna is not necessarily parallel to an axis direction of the hinge component, and may alternatively be at an angle relative to the axis of the hinge component. Further, in an embodiment, an outer contour of the first housing 1 is symmetric to an outer contour of the second housing 2, so that when the first housing 1 and the second housing 2 are in a folded state, the foldable electronic device provided in this embodiment has a more regular shape, making it easier to store.

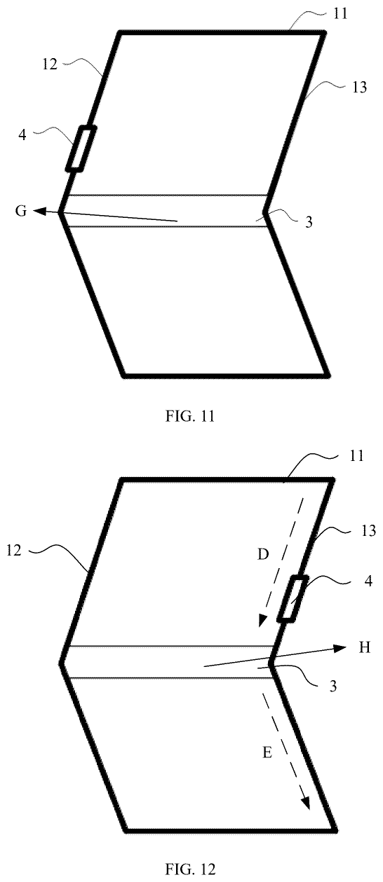

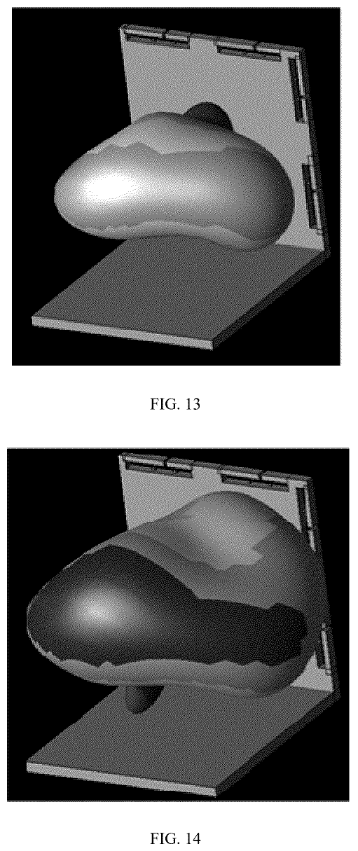

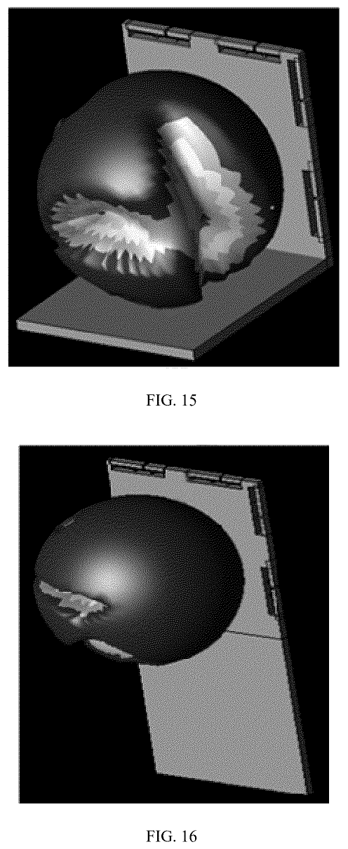

FIG. 11 is a diagram of a location of an antenna in a foldable electronic device in an embodiment according to embodiments of this application. As shown in FIG. 11, in an embodiment, the antenna 4 is located on the second side frame 12, and the distance between the feed point of the antenna 4 and the axis of the hinge component 3 is ¼ of the operating wavelength of the antenna 4. In this solution, the axis of the hinge component 3 is a forced boundary of the ground current, so that two current components generated by the ground current can form a circularly polarized radiation wave whose main radiation direction extends from the plane on which the third side frame and the sixth side frame are located to the plane on which the second side frame and the fifth side frame are located, that is, the main radiation direction of the circularly polarized radiation wave is a direction indicated by an arrow G in FIG. 11, so that the foldable electronic device has the satellite communication function. In another embodiment, as shown by a diagram of a location of an antenna in a foldable electronic device in an embodiment shown in FIG. 12, the antenna 4 is located on the third side frame 13, and the distance between the feed point of the antenna 4 and the axis of the hinge component 3 is ¼ of the operating wavelength of the antenna 4. In this solution, excitation of the antenna 4 generates a ground current, and the ground current is propagated along the ground plane as a traveling wave. The axis of the hinge component 3 is a forced boundary of the ground current, so that the ground current can generate two current components: a current D and a current E. Distances from the current D and the current E to the axis of the hinge component are equal. When the current D and the current E form a phase difference of 90° when passing through the axis of the hinge component, a circularly polarized radiation wave whose main radiation direction extends from the plane on which the second side frame and the fifth side frame are located to the plane on which the third side frame and the sixth side frame are located is formed, that is, the main radiation direction of the circularly polarized radiation wave is a direction indicated by an arrow H in FIG. 12, so that the foldable electronic device can implement communication with the satellite. When the foldable electronic device is in a half-folded state shown in FIG. 12, a left-handed circular polarization pattern of the antenna 4 is shown in FIG. 13, and a total radiation pattern of the antenna 4 is shown in FIG. 14. FIG. 15 is a simulation diagram of an axial ratio of a circularly polarized radiation wave radiated by the antenna 4 of the foldable electronic device that is in a half-folded state shown in FIG. 12. FIG. 16 is a simulation diagram of an axial ratio of a circularly polarized radiation wave radiated by an antenna 4 of the foldable electronic device shown in FIG. 13 that is in a flat state. By comparing the simulation diagrams of the axial ratios of the circularly polarized radiation waves radiated by the antenna 4 when the foldable electronic device is in a half-folded state and a flat state, it can be learned that a circular polarization characteristic of the electromagnetic wave radiated by the antenna 4 when the foldable electronic device is in a half-folded state is obviously improved, that is, the satellite communication performance is better when the foldable electronic device is in a half-folded state.

In the foregoing two embodiments, polarization handedness of the circularly polarized radiation waves formed by the antenna 4 is also different. Similarly, one is a left-handed circularly polarized radiation wave, and the other is a right-handed circularly polarized radiation wave. Details are described in the following. The location of the antenna 4 may be set based on polarization handedness of a circularly polarized radiation wave of the target satellite. If the target satellite of the antenna 4 is a satellite that radiates a left-handed circularly polarized radiation wave, the antenna 4 is disposed at a location at which the antenna 4 can form a left-handed circularly polarized radiation wave. If the target satellite of the antenna 4 is a satellite that radiates a right-handed circularly polarized radiation wave, the antenna 4 is disposed at a location at which the antenna 4 can form a right-handed circularly polarized radiation wave.

It can be learned from the foregoing description that, the foldable electronic device provided in this embodiment of this application can implement a better satellite communication function by setting the location of the antenna 4 in combination with the half-folded state of the foldable electronic device, so that a data amount and quality of satellite communication are improved. When the user is located in an area in which it is difficult for base station signals to reach, for example, outdoors, the user can better implement the functions such as SMS message, call, and multimedia can be better implemented by using the satellite communication function of the foldable electronic device.

During an arrangement of the first housing 1, the first side frame 11 may be parallel to the hinge component 3, and both the second side frame 12 and the third side frame 13 are perpendicular to the first side frame 11 and the hinge component 3, that is, the cross section of the first accommodating space formed by the side frames of the first housing 1 and the hinge component 3 is rectangular. A planar contour of a ground plane formed by the metal part in the first housing 1 is approximately the same as a planar contour of the first accommodating space. In other words, the ground plane formed by the metal part in the first housing 1 is also approximately rectangular. The ground plane formed by the metal part in the first housing 1 is approximately rectangular. This helps generate the two current components that are perpendicular to each other on the ground plane, to form a more desirable circularly polarized radiation wave. It should be noted that a rounded angle may be formed between two adjacent side frames of the first housing 1 or the second housing 2.

It is not difficult to understand that in the foldable electronic device provided in this embodiment of this application, the antenna 4 is a side frame antenna, for example, a left-handed antenna (composite right and left hand (CRLH)) or an inverted F antenna (IFA). For example, in an embodiment, the side frame of the first housing 1 is a metal side frame, and the primary radiator is a part of the metal side frame. In another embodiment, the side frame of the first housing 1 is an insulating side frame. For example, the side frame of the first housing 1 is a plastic side frame or a glass side frame. For example, in this case, the primary radiator may be a metal coating or a metal part of a flexible circuit board that is disposed on the side frame of the first housing 1.

In an embodiment, the preset angle is 60° to 120°, for example, 60°, 75°, 90°, or 120°.

It is not difficult to understand that the foldable electronic device mentioned in embodiments of this application may be of a vertical folding structure, or a horizontal folding structure. For example, the foldable electronic device is in an unfolded state in a conventional use process. When the foldable electronic device is of a vertical folding structure, the first housing 1 may be a housing located above the hinge component 3, or a housing located below the hinge component 3. When the foldable electronic device is of a horizontal folding structure, the first housing 1 may be a housing located on the left of the hinge component 3, or a housing located on the right of the hinge component 3.

The following uses an example in which the foldable electronic device is in a half-folded state in a conventional use process, to briefly describe an example disposition of the antenna 4 when the foldable electronic device is of a vertical folding structure.

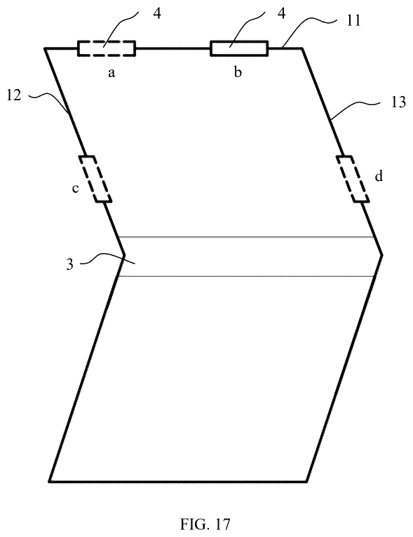

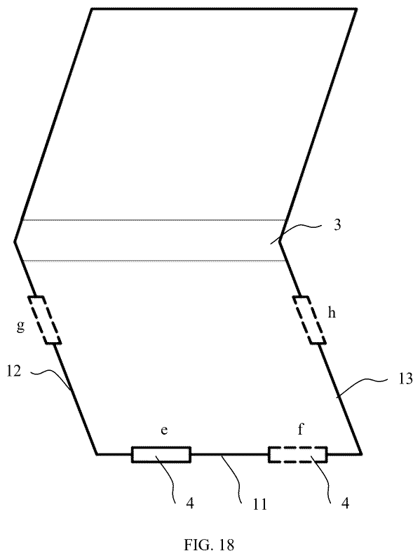

FIG. 17 is a diagram of a location of an antenna in a foldable electronic device in some embodiments. As shown in FIG. 17, the first housing 1 is a housing located above the hinge component 3, the first side frame 11 is located above the hinge component 3, and the second side frame 12 and the third side frame 13 are respectively located at left and right ends of the first side frame 11. For example, the antenna 4 is located on the first side frame 11, and the distance between the feed point of the antenna 4 and the edge that is of the ground plane and that faces the second side frame 12 is ⅛ to ⅜ of the operating wavelength of the antenna 4. That is, the antenna 4 is located at a location a in FIG. 17. In this case, the antenna 4 forms a left-handed circularly polarized radiation wave, and a main radiation direction of the left-handed circularly polarized radiation wave is located between the first housing 1 and the second housing 2, and extends from the first housing 1 toward the direction away from the first housing 1 and the second housing 2. Alternatively, the antenna 4 is located on the first side frame 11, and the distance between the feed point of the antenna 4 and the edge that is of the ground plane and that faces the third side frame 13 is ⅛ to ⅜ of the operating wavelength of the antenna 4. That is, the antenna 4 is located at a location b in FIG. 17. In this case, the antenna 4 forms a right-handed circularly polarized radiation wave, and a main radiation direction of the right-handed circularly polarized radiation wave is located between the first housing 1 and the second housing 2, and extends from the first housing 1 toward the direction away from the first housing 1 and the second housing 2. Alternatively, the antenna 4 is located on the second side frame 12, and the distance between the feed point of the antenna 4 and the axis of the hinge component 3 is ⅛ to ⅜ of the operating wavelength of the antenna 4. That is, the antenna 4 is located at a location c in FIG. 17. In this case, the antenna 4 forms a right-handed circularly polarized radiation wave, and a main radiation direction of the right-handed circularly polarized radiation wave is located between the first housing 1 and the second housing 2, and points from the plane on which the third side frame and the sixth side frame are located to the plane on which the second side frame and the fifth side frame are located. Alternatively, the antenna 4 is located on the third side frame 13, and the distance between the feed point of the antenna 4 and the axis of the hinge component 3 is ⅛ to ⅜ of the operating wavelength of the antenna 4. That is, the antenna 4 is located at a location d in FIG. 17. In this case, the antenna 4 forms a left-handed circularly polarized radiation wave, and a main radiation direction of the left-handed circularly polarized radiation wave is located between the first housing 1 and the second housing 2, and points from the plane on which the second side frame and the fifth side frame are located to the plane on which the third side frame and the sixth side frame are located.

FIG. 18 is a diagram of a location of an antenna in a foldable electronic device in some embodiments. As shown in FIG. 18, in an embodiment, the first housing 1 is a housing located below the hinge component 3, the first side frame 11 is located below the hinge component 3, and the second side frame 12 and the third side frame 13 are respectively located at the left and right ends of the first side frame 11. The antenna 4 is located on the first side frame 11, and the distance between the feed point of the antenna 4 and the edge that is of the ground plane and that faces the second side frame 12 is ⅛ to ⅜ of the operating wavelength of the antenna 4. In other words, the antenna 4 is located at a location e in FIG. 18. In another embodiment, the antenna 4 is located on the first side frame 11, and the distance between the feed point of the antenna 4 and the edge that is of the ground plane and that faces the third side frame 13 is ⅛ to ⅜ of the operating wavelength of the antenna 4. In other words, the antenna 4 is located at a location f in FIG. 18. In another embodiment, the antenna 4 is located on the second side frame 12, and the distance between the feed point of the antenna 4 and the axis of the hinge component 3 is ⅛ to ⅜ of the operating wavelength of the antenna 4. In other words, the antenna 4 is located at a location g in FIG. 18. In still another embodiment, the antenna 4 is located on the third side frame 13, and the distance between the feed point of the antenna 4 and the axis of the hinge component 3 is ⅛ to ⅜ of the operating wavelength of the antenna 4. In other words, the antenna 4 is located at a location h in FIG. 18. A principle of the antenna is similar to that described when the first housing 1 is the housing located above the hinge component 3. Details are not described herein again.

It should be noted that, when the foldable electronic device is of a vertical folding structure, the first housing 1 is located above the hinge component 3, and the antenna 4 is located on the first side frame 11, that is, the antenna 4 is located on the top of the foldable electronic device, the circularly polarized radiation wave formed by the antenna 4 can better implement the satellite communication function. In addition, after the satellite communication function of the foldable electronic device is enabled, holding of the foldable electronic device by the user is closer to a conventional use state of the foldable electronic device, and user experience is better. When the antenna 4 is located on the second side frame 12 or the third side frame 13, after the satellite communication function of the foldable electronic device is enabled, the user needs to rotate the foldable electronic device, to align the main radiation direction of the antenna with the satellite. A state of the foldable electronic device after rotation is usually similar to that of the foldable electronic device of a horizontal folding structure. In addition, when using the foldable electronic device, the user usually holds a part that is of the foldable electronic device and that is close to a bottom end. If the antenna 4 is located at the bottom of the foldable electronic device, that is, the first housing is located below the hinge component 3, a hand of the user absorbs a radiation wave of the antenna 4, reducing a communication capability of the antenna 4. To avoid this case, the user needs to rotate the foldable electronic device to hold the second housing.

The following uses an example in which the foldable electronic device is in a half-folded state in a conventional use process, to briefly describe an example disposition of the antenna 4 when the foldable electronic device is of a horizontal folding structure.

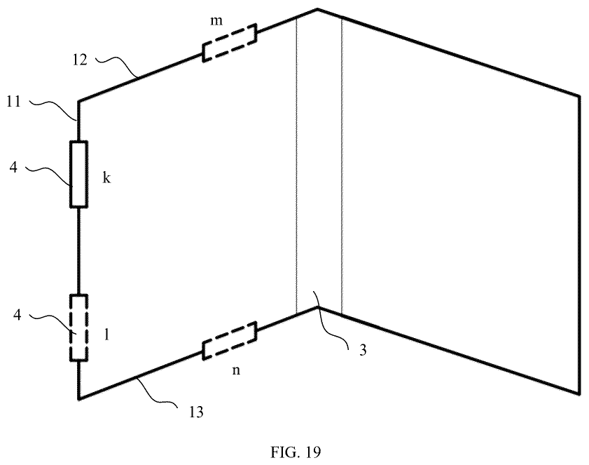

FIG. 19 is a diagram of a location of an antenna in a foldable electronic device in some embodiments. As shown in FIG. 19, the first housing 1 is a housing located on the left of the hinge component 3, the first side frame 11 is located on the left of the hinge component 3, and the second side frame 12 and the third side frame 13 are respectively located at upper and lower ends of the first side frame 11. Further, in an embodiment, the antenna 4 is located on the first side frame 11, and the distance between the feed point of the antenna 4 and the edge that is of the ground plane and that faces the second side frame 12 is ⅛ to ⅜ of the operating wavelength of the antenna 4. In other words, the antenna 4 is located at a location k in FIG. 19. In another embodiment, the antenna 4 is located on the first side frame 11, and the distance between the feed point of the antenna 4 and the edge that is of the ground plane and that faces the third side frame 13 is ⅛ to ⅜ of the operating wavelength of the antenna 4. In other words, the antenna 4 is located at a location 1 in FIG. 19. In another embodiment, the antenna 4 is located on the second side frame 12, and the distance between the feed point of the antenna 4 and the axis of the hinge component 3 is ⅛ to ⅜ of the operating wavelength of the antenna 4. In other words, the antenna 4 is located at a location m in FIG. 19. In still another embodiment, the antenna 4 is located on the third side frame 13, and the distance between the feed point of the antenna 4 and the axis of the hinge component 3 is ⅛ to ⅜ of the operating wavelength of the antenna 4. In other words, the antenna 4 is located at a location n in FIG. 19.

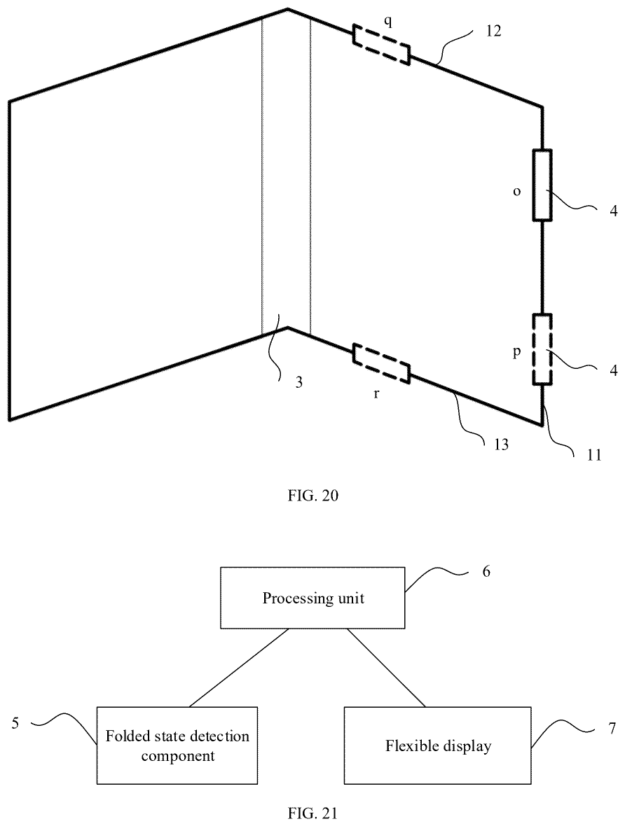

FIG. 20 is a diagram of a location of an antenna in a foldable electronic device in some embodiments. As shown in FIG. 20, in an embodiment, the first housing 1 is a housing located on the right of the hinge component 3, the first side frame 11 is located on the right of the hinge component 3, and the second side frame 12 and the third side frame 13 are respectively located at upper and lower ends of the first side frame 11. For example, in an embodiment, the antenna 4 is located on the first side frame 11, and the distance between the feed point of the antenna 4 and the edge that is of the ground plane and that faces the second side frame 12 is ⅛ to ⅜ of the operating wavelength of the antenna 4. In other words, the antenna 4 is located at a location o in FIG. 20. In another embodiment, the antenna 4 is located on the first side frame 11, and the distance between the feed point of the antenna 4 and the edge that is of the ground plane and that faces the third side frame 13 is ⅛ to ⅜ of the operating wavelength of the antenna 4. In other words, the antenna 4 is located at a location p in FIG. 20. In another embodiment, the antenna 4 is located on the second side frame 12, and the distance between the feed point of the antenna 4 and the axis of the hinge component 3 is ⅛ to ⅜ of the operating wavelength of the antenna 4. In other words, the antenna 4 is located at a location q in FIG. 20. In still another embodiment, the antenna 4 is located on the third side frame 13, and the distance between the feed point of the antenna 4 and the axis of the hinge component 3 is ⅛ to ⅜ of the operating wavelength of the antenna 4. In other words, the antenna 4 is located at a location r in FIG. 20.

It should be noted that, when the foldable electronic device is of a horizontal folding structure, and the antenna 4 is located on the second side frame 12, that is, the antenna 4 is located on the top of the foldable electronic device, the circularly polarized radiation wave formed by the antenna 4 can better implement the satellite communication function. In addition, after the satellite communication function of the foldable electronic device is enabled, holding of the foldable electronic device by the user is closer to a conventional use state of the foldable electronic device, and user experience is better. When the antenna 4 is located on the first side frame 11, after the satellite communication function of the foldable electronic device is enabled, the user needs to rotate the foldable electronic device, to align the main radiation direction of the antenna with the satellite. A state of the foldable electronic device after rotation is usually similar to that of the foldable electronic device of a vertical folding structure. In addition, when using the foldable electronic device, the user usually holds a part that is of the foldable electronic device and that is close to a bottom end. If the antenna 4 is located at the bottom of the foldable electronic device, a hand of the user absorbs a radiation wave of the antenna 4, reducing a communication capability of the antenna 4. To avoid this case, when the foldable electronic device is of the horizontal folding structure, the user needs to hold one end that is of the foldable electronic device and that is opposite to a side frame on which the antenna is located, so that the antenna 4 is located on the top of the foldable electronic device. It should be understood that, when the foldable electronic device is of a horizontal folding structure, a principle of the antenna is similar to that described when the foldable electronic device is of a vertical folding structure described above. Details are not described herein again.

It should be understood that the foldable electronic device further includes a flexible display 7, where the flexible display 7 continuously covers the first housing 1, the hinge component 3, and the second housing 2, and the flexible display 7 is fastened to both the first housing 1 and the second housing 2. Further, FIG. 21 is a diagram of a foldable electronic device in an embodiment according to embodiments of this application. In an embodiment, the foldable electronic device further includes a folded state detection component 5 and a processing unit 6. Both the folded state detection component 5 and the flexible display 7 are electrically connected to the processing unit 6. The folded state detection component 5 is configured to detect an angle of the included angle between the first housing 1 and the second housing 2. For example, the folded state detection component 5 may be a sensor component. The processing unit 6 stores a correspondence between earth coordinates and an elevation angle of the satellite, and further stores a correspondence between the included angle between the first housing 1 and the second housing 2 and the main radiation direction of the antenna 4, so that the processing unit 6 is capable of controlling, based on feedback from the folded state detection component 5, the flexible display 7 to guide the user to align the main radiation direction of the antenna 4 with the satellite. In other words, the processing unit 6 can invoke, based on the correspondence between the geographical location of the user and the elevation angle of a satellite and the angle that is of the included angle between the first housing 1 and the second housing 2 and that is fed back by the folded state detection component 5, the correspondence between the included angle between the first housing 1 and the second housing 2 and the main radiation direction of the antenna 4, and guide, by using the flexible display 7, the user to rotate the foldable electronic device, to align the main radiation direction of the antenna 4 with the satellite. It is not difficult to understand that, when the satellite communication function is enabled, the foldable electronic device is in a half-folded state, and an included angle between the first housing 1 and the second housing 2 can be maintained at the preset angle, so that satellite communication performance of the foldable electronic device is better. It should be noted that, when the included angle between the first housing 1 and the second housing 2 is maintained at 90°, after the satellite communication function of the foldable electronic device is enabled, a circular polarization axial ratio of the antenna 4 is better, and satellite communication performance is better.

The following briefly describes main use scenarios of the foldable electronic device provided in embodiments of this application. After the satellite communication function of the foldable electronic device is enabled, the flexible display 7 of the foldable electronic device may prompt the user to fold the foldable electronic device to 60° to 120°, to improve a gain of the antenna 4, and provide a more stable and high-quality satellite communication service. In an embodiment, after the satellite communication function of the foldable electronic device is enabled, the flexible display 7 of the foldable electronic device informs the user that an angle at which the foldable electronic device is folded may be 60°, 75°, 90°, or 120°. Then, the processing unit 6 of the foldable electronic device invokes, based on the correspondence between the geographical location of the user and the elevation angle of a satellite and the angle that is of the included angle between the first housing 1 and the second housing 2 and that is fed back by the folded state detection component 5, the correspondence between the included angle between the first housing 1 and the second housing 2 and the main radiation direction of the antenna 4, and guide, by using a user interface (UI) of the flexible display 7, the user to rotate the foldable electronic device, to align the main radiation direction of the antenna 4 with the satellite.

Certainly, the antenna mentioned in embodiments of this application may alternatively be an antenna of another standard, for example, a Wi-Fi antenna or a cellular antenna, to communicate with a terminal device in a Wi-Fi network or a cellular network.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A foldable electronic device, comprising:
a first housing comprising a plurality of side frames, wherein the plurality of side frames comprise at least a first side frame, a second side frame, and a third side frame,
a second housing, the second housing and the first housing respectively disposed on two sides of a hinge component, wherein:
at least one of the first housing or the second housing is rotatably connected to the hinge component,
an included angle between the first housing and the second housing is capable of being maintained at a preset angle,
the second side frame and the third side frame are respectively located at two ends of the hinge component, and
the first side frame is located between sides that are of the second side frame and the third side frame and that are away from the hinge component;
a metal part in the first housing, a metal part in the second housing, and a metal part in the hinge component are electrically connected as a ground plane; and
an antenna located on a side frame of the first housing, the antenna comprising a primary radiator and a feed point located on the primary radiator; and wherein:
when the antenna is located on the first side frame, a distance between the feed point and an edge that is of the ground plane and that faces the second side frame or the third side frame is ⅛ to ⅜ of an operating wavelength of the antenna; or
when the antenna is located on the second side frame or the third side frame, a distance between the feed point and an axis of the hinge component is ⅛ to ⅜ of the operating wavelength of the antenna.

2. The foldable electronic device according to claim 1, wherein when the antenna is located on the first side frame, the distance between the feed point and the edge that is of the ground plane and that faces the second side frame or the third side frame is ¼ of the operating wavelength of the antenna.

3. The foldable electronic device according to claim 1, wherein when the antenna is located on the second side frame or the third side frame, the distance between the feed point and the axis of the hinge component is ¼ of the operating wavelength of the antenna.

4. The foldable electronic device according to claim 1, wherein the first side frame is parallel to the hinge component, and both the second side frame and the third side frame are perpendicular to the first side frame and the hinge component.

5. The foldable electronic device according to claim 1, wherein when the foldable electronic device is in a use state, the antenna is located at a top of the foldable electronic device.

6. The foldable electronic device according to claim 1, wherein the preset angle is 60° to 120°.

7. The foldable electronic device according to claim 6, wherein the preset angle is 90°.

8. The foldable electronic device according to claim 1, comprising a flexible display, wherein the flexible display continuously covers the first housing, the hinge component, and the second housing, and the flexible display is fastened to the first housing and the second housing.

9. The foldable electronic device according to claim 8, further comprising:
a folded state detection component and a processing unit, wherein both the folded state detection component and the flexible display are electrically connected to the processing unit; and
the folded state detection component is configured to detect an angle of the included angle between the first housing and the second housing; the processing unit stores a correspondence between earth coordinates and an elevation angle of a satellite, and further stores a correspondence between the included angle between the first housing and the second housing and a main radiation direction of the antenna; and the processing unit is capable of controlling, based on feedback from the folded state detection component, the flexible display to guide a user to align the main radiation direction of the antenna with the satellite.

10. The foldable electronic device according to claim 1, wherein the antenna is a left-handed antenna or an inverted F antenna.

11. The foldable electronic device according to claim 1, wherein the side frame is a metal side frame, and the primary radiator is a part of the metal side frame.

12. The foldable electronic device according to claim 1, wherein the side frame is an insulating side frame, and the primary radiator is a metal coating or a metal part of a flexible circuit board.
